(19) United States
(12) Patent Application Publication
(10) Pub. No.: US 2008/0042446 A1
(43) Pub. Date: Feb. 21, 2008

(54) Wind powered devices

(76) Inventor: William C. Kurtz, St. Croix Falls, WI (US)

Correspondence Address: Curtis D. Kinghorn;Sirius Strategic, LLC, 6769 W. Shadow Lake Dr., Lino Lakes, MN, 55014, US

(21) Appl. No.: 11/811,679

(22) Filed: Jun. 11, 2007

Related U.S. Application Data
(60) Provisional application No. 60/812,169, filed on Jun. 9, 2006.

(51) Int. Cl. H02P 9/04; F03D 9/00

(52) U.S. Cl. 290/55

(57) ABSTRACT

Devices for converting wind energy into other usable forms of energy are disclosed. In one embodiment of the invention, a wind device having at least one but more preferably two vertically directed cylindrical windmills are disposed on the ends of a “V” shaped structure so that half of each windmill is exposed to contact by the wind moving along the outer surface of the “V” as the point of the “V” is aimed into the wind. In this configuration, the other half of each windmill is located within the “V” shaped structure where this half does not come into contact with the wind. As a result, the wind contacting the outside half of each windmill causes the windmill to rotate. Each rotating windmill is mechanically connected to a device to convert the rotation of the windmills into another form of energy. In a variant of this embodiment, the vanes are located a distance from the axis of rotation in order to generate more torque in light winds. In another variant of the invention, wind devices are located in locations where there is a relatively large amount of wind such as on cars, trucks, busses, trains, ships, bicycles or airplanes, near on or in tunnels or near the ends of runways so that propeller blast or jet wash from departing aircraft may be captured by the invention and converted into usable energy as described above.

### BACKGROUND OF THE INVENTION

1. Field of the Invention

This invention relates to devices for converting wind energy into other usable forms of energy.

2. Description of Related Art

It is estimated that 1% to 3% of solar energy that hits the Earth is converted naturally into wind energy. This is about 50 to 100 times more energy than is converted into biomass by all the plants on Earth through photosynthesis. Obviously this is a large amount of energy, most of which is not converted into other forms of usable energy.

Most of this wind energy is found at high altitudes. However, some of the wind is found close to the Earth's surface. Over the years, many devices have been developed that convert this wind energy found close to the Earth into other forms of usable energy. For example, windmills have been developed that convert wind energy into mechanical energy that is used to crush grain or pump water.

Relatively recently, wind energy has been converted into electrical energy by wind contacting and turning turbine blades which are mechanically connected to generators to generate electricity as the wind turns the turbine blades. Due to issues associated with energy generation by and use of non-renewable resources, particularly fossil fuels such as coal, natural gas and oil, there has been much interest recently in devices to convert wind energy, a renewable resource, into other forms of energy particularly electrical energy. As a result, large windmill arrays are now found in many countries. Further, particularly in remote areas, small household windmill generators typically producing around a view hundred watts to several kilowatts of electrical energy are found near many homes. As a result, at the end of 2006 the worldwide capacity of wind-power generators was estimated to be 74, 223 megawatts which was approximately 4 times the power produced by wind in 2000. Despite the attractiveness of wind as a renewable energy source, only a tiny fraction of the available wind energy as so far been converted into other usable forms of energy such as electrical energy.

### SUMMARY OF THE INVENTION

Devices for converting wind energy into other usable forms of energy are disclosed. In one embodiment of the invention, a wind device having at least one but more preferably two vertically directed cylindrical windmills are disposed on the ends of a “V” shaped structure so that half of each windmill is exposed to contact by the wind moving along the outer surface of the “V” as the point of the “V” is aimed into the wind. The V-shaped structure is preferably but not absolutely allowed to rotate so that it forms a natural wind vane turning into the wind.

In this configuration, the other half of each windmill is located within the “V” shaped structure where this half does not come into contact with the wind. As a result, the wind contacting the outside half of each windmill causes the windmill to rotate. Each rotating windmill is mechanically connected to a device to convert the rotation of the windmills into another form of energy. For example, the windmills are preferably connected to an electrical generator, an air compressor, hydraulic pump or a fluid or gas pump to convert mechanical rotation of the windmill into other forms of usable energy.

In a variant of this invention, the vanes are located a distance from each axis of rotation, preferably by attaching the vane to an axis of rotation through a connector arm. In this configuration, greater torque is imparted to the axis of rotation, and ultimately to device for converting this rotational energy into another form of energy such as an electrical generator, air compressor, hydraulic pump or fluid or gas pump. This embodiment may be particularly useful in areas where or at times when the wind contacting a vane is light.

In another variant of this invention, the top of the wind device is covered with a solar panel that converts incidence sunlight into electricity in order to further add to the energy collecting capability of the invention. Where the invention generates electricity, the electricity may be used directly in the vicinity of the invention or may be connected to a larger power grid or may be used for other local purposes.

In addition, the electricity generated by the wind device, whether from the windmill or from a solar panel or through a purely mechanical connection may be used to power a pump or an air compressor to produce compressed air which may be used for a variety of functions as is commonly understood in the art. In addition, power from the electrical generator may be used to generate hydrogen and oxygen which may also be used as energy sources as it is also well understood in the art.

In a variant of the invention, wind devices are located in locations where there is a relatively large amount of wind. For example, wind devices may be placed on cars, trucks, busses, trains, ships, bicycles or airplanes so that as they move, the wind generated by their movement in addition to any naturally occurring land, if any, may be used to turn windmills to provide the benefits described above.

In another variant of the invention, the wind devices may be placed near on or in tunnels so wind movement through the tunnels or movement of wind through tunnels generated by passing cars, trucks, busses or trains all or in any combination of these may interact with the windmills to produce the desired benefits described above.

In another variant of the invention the present invention may be placed near the ends of runways so that propeller blast or jet wash from departing aircraft may be captured by the invention and converted into usable energy as described above. In a further variant of this invention, wind devices may be placed on ships, particularly aircraft carriers that are turned into the wind in order to enable the takeoff and landing of aircraft from such ships.

It is therefore an object of the present invention in one or more embodiments to provide devices that convert wind energy into other usable forms of energy.

It is therefore an object of the present invention in one or more embodiments to provide devices that convert wind energy, particularly light wind, into other usable forms of energy.

It is a further object of the invention in one or more embodiments to provide devices that combine collecting energy from wind with collecting energy from a solar panel.

It is another object of the invention in one or more embodiments to provide devices that may be used on moving vehicles or other objects of transportation to convert wind passing by such objects into usable forms of energy.

It is another object of the invention in one or more embodiments to provide devices that may be used on moving vehicles or other objects of transportation to increase the drag on such objects in order to assist such objects in stopping.

Not all of these objects need be present in a single embodiment. Instead, a particular embodiment may have one or more of these objects. These and other objects of the invention will be clear from the following detailed description of the invention in connection with the drawings

### BRIEF DESCRIPTION OF THE DRAWINGS

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. In addition, the exact dimensions and dimensional proportions to conform to specific force, weight, strength and similar requirements will be within the skill of the art after the following description has been read and understood.

All Figures are drawn for ease of explanation of the basic teachings of the present invention only; the extensions of the Figures with respect to number, position, relationship, and dimensions of the parts to form examples of the various embodiments will be explained or will be within the skill of the art after the following description has been read and understood. Further, the exact dimensions and dimensional proportions to conform to specific force, weight, strength and similar requirements will likewise be within the skill of the art after the following description has been read and understood.

FIG. 1 is a perspective of one embodiment of the wind device of the present invention.

FIG. 2 is a top view of the wind device of FIG. 1.

FIG. 3 is a side view of the wind device of FIG. 1.

FIG. 4 is a top schematic view of an alternate embodiment of the propeller of the invention of FIG. 1.

FIG. 5 is a side schematic view of an alternate embodiment of the propeller of the invention of FIG. 1.

FIG. 6 is a side schematic view of an alternate embodiment of the propeller of the invention of FIG. 1.

FIG. 7 is a side schematic view of an embodiment of the invention.

FIG. 8 is a side schematic view of another embodiment of the invention.

FIG. 9 is a side schematic view of another embodiment of the invention.

FIG. 10 is a side schematic view of another embodiment of the invention.

FIG. 11 is a side schematic view of another embodiment of the invention.

FIG. 12 is a top schematic view of another embodiment of the invention.

### DETAILED DESCRIPTION OF THE INVENTION

In order that the invention may be clearly understood and readily carried into effect, preferred embodiments of the invention will now be described, by way of example only and not to limit the invention, with reference to the accompanying drawings. The wind devices of the present invention are shown in the drawings generally labeled 10.

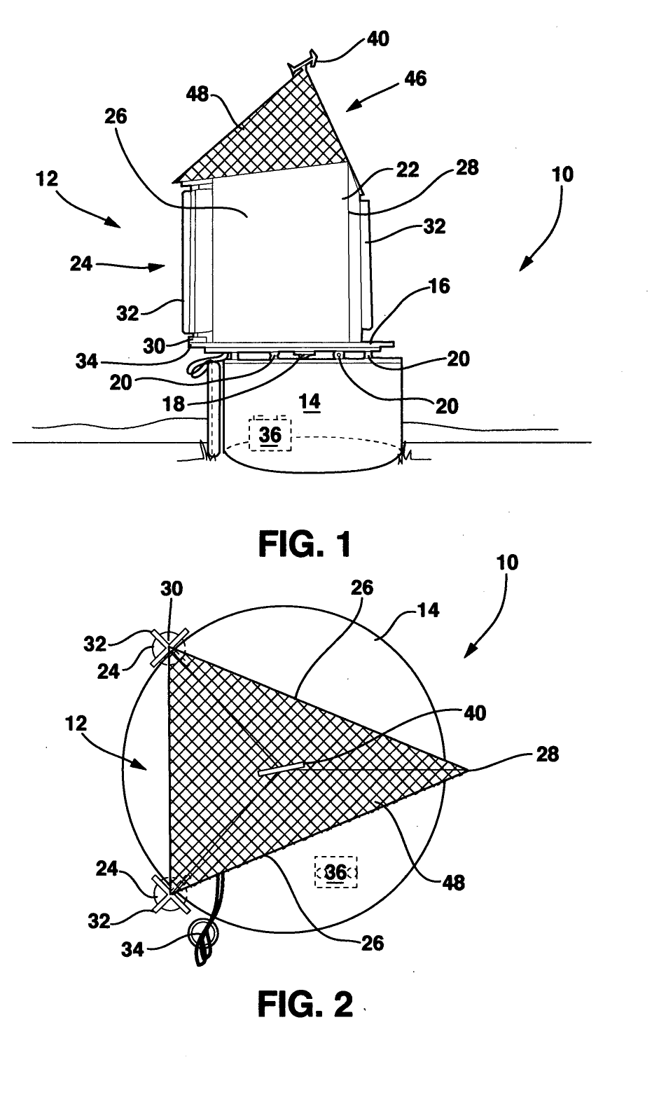

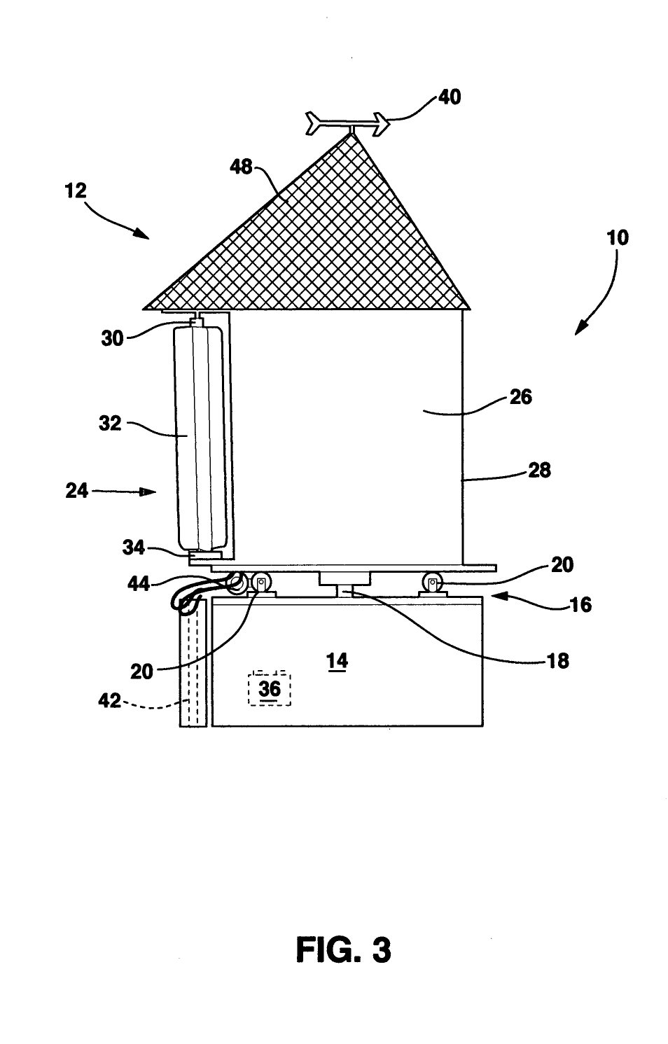

The wind device 10, in an embodiment shown in FIGS. 1-3, includes a wind collector 12 and a support structure 14. Wind collector 12 interacts with the wind to capture energy from the wind do a desired task as will be explained hereafter. Support structure 14 provides a base and a support for the wind collector 12 and places the wind collector 12 in contact with the wind. As such, support structure 14 can have many sizes, shapes and configurations so long as the support structure 14 securely supports and places the wind collector 12 in a position to be contacted by and interact with the wind.

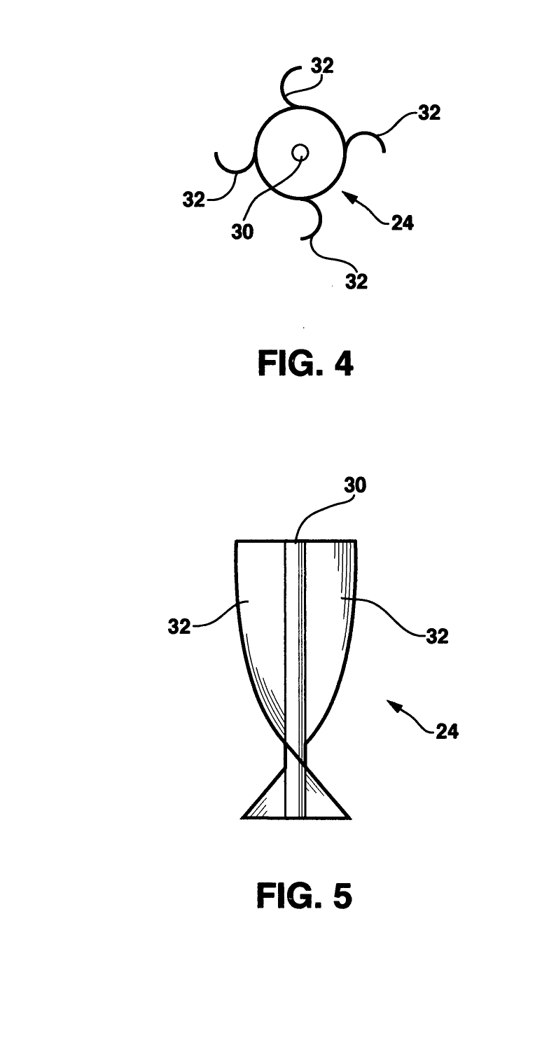

For example, in the embodiment of the support structure 14 shown in FIGS. 1 and 4, the support structure 14 is anchored in the ground so that it supports the wind collector 12 a short distance above the ground. In this embodiment, the support structure 14 may be a concrete pillar placed into the ground and extending a distance above the ground to support the wind collector 12. Although a concrete pillar could be used, other structures that are more or less solid and robust, including but not limited to towers or platforms could also be used for the support tower 13. Alternately, the support structure 14 could extend a considerable distance above the ground.

In addition, the support structure 14 could take the form of an already existing structure such as a silo, tower, bridge, billboard or building so that the wind collector 12 is attached to the silo, tower, bridge, billboard or building. Further, the support structure 14 or the entire wind device 10 itself may be placed along the sides of structures such as buildings, particularly on or in the corners of buildings, so that wind can contact the wind collector 12.

In the wind device 10 shown in FIGS. 1-3, the wind device 10 also preferably allows the wind collector 12 to rotate on a turntable 16. In one embodiment, the turntable 16 has a pivot 18 to allow the wind collector 12 to be turned so as to have maximum beneficial interaction with the available wind. As a result, the turntable 16 may be of the type commonly referred to as a “lazy Susan”, and is placed between the support structure 14 and the wind collector 12 so that the wind collector 12 pivots around the turntable 16. In one embodiment of the invention, the turntable 16 includes a series of rollers 20 placed between the support structure 14 and the wind collector 12 to allow the turntable 16 to rotate around a pivot 18. Although a particular structure has been described in connection with the turntable 16, it is clear that many other configurations, well-known in the art, could be used to allow the wind collector 12 to rotate around a pivot point on the support structure 14 and are intended to be part of the invention.

Wind collector 12 in the embodiments of FIGS. 1-3 preferably includes a wind vane splitter 22 to split and direct the wind to contact propellers 24 and to increase the intensity of the wind as will be described hereafter and, in one embodiment, aim the wind collector 12 into the wind. As seen in FIG. 2, wind vane splitter 22 has a “V” shaped configuration formed by two legs 26 extending away from a point 28. The triangular shape of the wind vane splitter 22 acts in the nature of tetrahedron wind vane to point the point 28 into the wind as the wind collector 12 interacts with the wind and is allowed to rotate around the turntable 16. Also, the triangular shape of the wind vane splitter 22 acts to increase the intensity of the wind presented to the propellers 24. This increase in intensity occurs because the wedge shape of the wind vane splitter 22 causes the entire wind incident upon the legs 26 to be concentrated on the ends of the legs 26. In order to maintain smooth airflow past the wind vane splitter 22, the wind incident on the legs 26 must increase in speed as it approaches the ends of the legs 26 (where the propellers 24 are located). The legs 26 of the “V” shape may have a smaller or larger separation depending on such factors as the amount and intensity of the wind, the desired increase in wind velocity due to the wedging action of the wind vane splitter 22 and the size of the wind device 10.

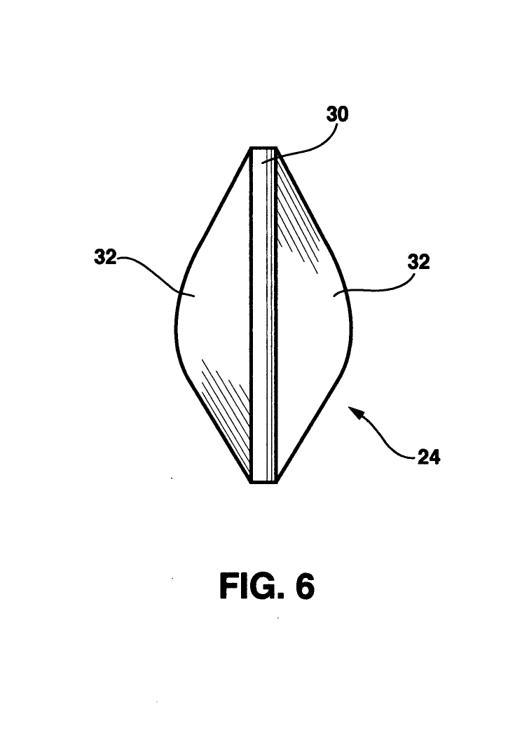

The wind collector 12 includes at least one propeller 24. In the embodiment shown in FIGS. 1-3, there are two propellers 24 located at the open ends of the legs 26 of the “V” shaped wind vane splitter 22. In the embodiment shown in FIGS. 1-3, these propellers 24 are vertically oriented and rotate around a propeller axis 30. These propellers 24 in one embodiment have at least one vane 32 extending radially away from the propeller axis 30. These vanes 32 in the embodiment shown in FIGS. 1-3 are flat slats although in other embodiments they may take other shapes including, but not limited to, cup-shaped slats (FIG. 4), helical slats (FIG. 5) or curved slats (FIG. 6).

Depending on the configuration of the vanes 32, there must be at least one vane 32 (e.g., a helical vane 32 that wraps around the propeller axis 30) but could be many vanes 32 (e.g., many flat vanes 32 extending radially from the propeller axis 30). In the embodiment shown in FIG. 2 where the vanes 32 are flat slats, each propeller 24 has four vanes 32 although as few as two vanes 32 could be used or more than four vanes 32 could be used.

Each propeller axis 30 is rigidly but rotatably attached to the wind vane splitter 22 at both the top 33 and bottom 35 of the propeller axis 30. This allows each propeller 24 to spin around the propeller axis 30. The propeller axis 30, as shown in FIG. 2, is preferably located in line with the legs 26 of the wind vane splitter 22 so that approximately half of the propeller 24, and consequently at least one vane 32, is exposed to the wind that travels down the legs 26. In the embodiment of the wind device 10 shown in FIGS. 1-3, the propeller axis 30 is oriented in a vertical direction. However, the propeller axis 30 may also be oriented in a horizontal axis or any orientation between vertical and horizontal so long as the vanes 32 are placed so that they are contacted by wind.

As described above, in one embodiment approximately half of the propeller 24 is exposed to the wind passing down the legs 26 of the wind vane splitter 22. Consequently, once the wind vane splitter 22 is turned into the wind, wind will move along either side of the legs 26 of the wind vane splitter and contact tax the vanes 32 of the propellers 24. Because the wind is contacting the vanes 32 on one side of the propeller axis 30, the wind is prevented from contacting the vanes 32 on the other side of the propeller axis 30. As a result, uneven the pressure is exerted on the vanes 32 causing the propellers 24 to rotate around the propeller axis 30.

The propeller axis 30 is preferably connected to a device for converting rotational motion around the propeller axis 30 into a useful form of energy. In one preferred embodiment, the propeller axis 30 is attached to an electrical generator 34 so that as the propellers 24 rotate around the propeller axis 30 due to the interaction of the vanes 32 with the wind, electrical energy is generated by the electric generator 34.

In one embodiment of the invention, the electric generator 34 is connected to an exchange battery 36 that stores the electrical energy generated by the electric generator 34. Alternately, the electric generator 34 can be connected directly to an electric grid through appropriate hardware as is well understood in the art in connection with connecting electrical generators to such grids.

In a further embodiment, the electoral generator 34 can produce electricity that is directly applied to water to create hydrogen and oxygen through electrolysis. The hydrogen and oxygen may then be collected and either used directly or stored for use (e.g., combustion) as is well understood with hydrogen and oxygen systems.

Alternately, the propeller axis 30 can be connected to other devices to produce useful energy such as an air compressor 38, hydraulic pump or fluid or gas pump, such as is well understood in the art. In this embodiment, rotation of the propellers 24 around their propeller axes 30 may produce compressed air which may then either be used directly or stored for later use. Alternately, rotation of the propellers 24 around their propeller axes 30 may actuate a hydraulic pump to create hydraulic action for any purpose common to hydraulic tools as is well understood in the art. Further, rotation of the propellers 24 around their propeller axes 30 may actuate a fluid or gas pump for any purpose common to such pumps as is well understood in the art.

Alternately, one propeller 24 may be connected to one device for converting rotation of the propeller 24 into useful energy (e.g., an electrical generator 34) while another propeller 24 may be connected to another device for converting rotation of the propeller 24 into useful energy (e.g., an air compressor 38). Obviously, various propellers 24 may be connected in any combination to various devices for converting rotation of the propeller 24 into useful energy. Further, two or more propellers 24 may be mechanically connected to a single device for converting rotation of the propeller 24 into useful energy (e.g., an electrical generator 34). In this way, more power may be presented to a device for converting rotation of the propeller 24 into useful energy than would be presented to such device from a single propeller 24. In addition, one propeller 24 may be mechanically connected to more than one device for converting rotation of the propeller 24 into useful energy (e.g., an electrical generator 34 and an air compressor 38).

In one embodiment of the invention shown in FIGS. 1-3, the wind collector 12 includes a wind vane splitter 22 as described above to aim the wind collector 12 into the wind. In another embodiment of the invention, the wind collector 12 may be turned into the wind by operation of a system including a small wind vane 40 that senses the direction of the wind and sends a signal to a control system 42 that has a mechanism 44 to turn the wind collector 12 into the wind to provide maximum contact between the wind and the propellers 24. The mechanism 44 may be a small motor that interacts with the turntable 16 to rotate the wind collector 12 into a desired configuration with respect to the wind. The wind vane 40 may take any of a number of well-known shapes for wind vanes so long as the wind vane 40 is able to sense the direction of the wind and relay it to the control system 42.

In a preferred embodiment, the wind collector 12 includes a top 46 covering at least the wind vane splitter 22. One function of the top 46 is to provide a cover for the wind vane splitter 22 so that dirt, debris or animal or bird nests are less likely to be formed within the wind vane splitter 22. In a preferred embodiment of the wind device 10, the top 46 includes a solar panel 48 that converts sunlight into electrical energy. The solar panel 48 is preferably connected to the electrical system that the electrical generator 34 is attached to where there is an electrical generator 34 as described above or may produce an independent application of electrical energy whether there is an electrical generator 34 or not.

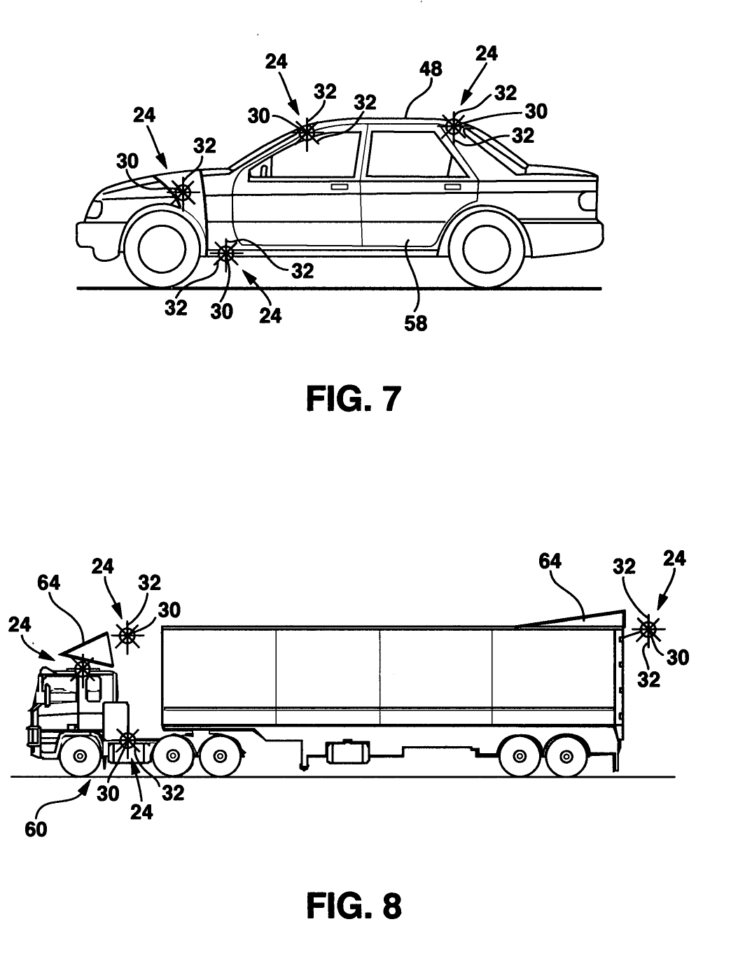

In another embodiment of the invention, wind devices 10 are located in locations where there is a relatively large amount of wind, either naturally created or created by the movement of a vehicle. For example, wind devices 10 may be placed on a car 58 (FIG. 7) or a truck 60 (FIG. 8) so that as they move, the wind generated by their movement, in addition to any naturally occurring wind if any, may be used to turn propellers 24 to provide the benefits described above.

For example, as shown in FIG. 7, some propellers 24 are located so that approximately half of each propeller 24 is exposed to the wind while the other half of each propeller 24 is sheltered from the wind. In this configuration, the interaction of the wind with the part of the propeller 24 exposed to the wind creates an unbalanced force in the propeller 24 that causes the propeller 24 to rotate around an axis 62.

In this application as shown in FIG. 7, it may be desirable for the axis 62 to be horizontal instead of vertical. However, depending on many factors including the availability of space on the car 58 to locate such propellers 24, the axis 62 may be vertical or any angle between horizontal and vertical. As a result, and without limitation, the propellers 24 could be located on the roof of a car 58, along the bottom surface, side or virtually anywhere along the car where wind passes as the car 58 moves. Although the location of the propeller 24 has been described in connection with a car 58, these locations apply equally well to any other vehicle as will be described hereafter and as will be clear to those skilled in the art.

Likewise, propellers 24 may be located on a truck 60, such as is shown schematically in FIG. 8, along the roof, bottom, or back edge of a trailer, in either vertical or horizontal configurations, as well as configurations in between. With respect to the embodiment of the wind device 10 applied to cars 58 or trucks 60, it is also preferable that at least part of the car 58 or truck 60 have a solar panel 48 attached thereto to convert incident sunlight into electrical energy as described above.

Further, the car 58, truck 60 or other vehicle could have at least one deflector 64 functionally located close to a particular propeller 24 to control the amount of and even whether any wind contacts the propellers 24. For example, it may be desirable for the deflector 64 to move to a first position to deflect the wind over the propellers 24 when traveling uphill in order to minimize the drag and maximize the efficiency of the car 58 or truck 60 traveling up the hill. However, it may be desirable to move the deflector 64 into a second position that allows a desired amount (e.g., a maximum amount) of wind to contact half of a propeller 24 as described above when the truck 60 is going downhill or when braking in order to maximize the amount of drag produced by the propeller 24.

As described above, preferably approximately half of a propeller 24 is directly exposed to contact with the wind produced by a vehicle as it moves. Alternately wind devices 10 may be placed within the confines of a car 58, truck 60 or other vehicle. In this embodiment, wind from movement of the car 58, truck 60 or other vehicle may be directed to the wind device 10 through one or more ducts 66 that capture a portion of the wind and direct it into contact with the wind devices 10.

It may also be desirable to allow one or more propellers 24 to free-wheel (i.e., not be functionally connected to either the electrical generator 34, air compressor 38, hydraulic pump or fluid or gas pump) in normal operation in order to reduce drag and increase gas mileage. However, it may be desirable to then selectively activate the propellers 24 (i.e., functionally connect them to the electrical generator 34, air compressor 38, hydraulic pump or fluid or gas pump) for example upon applying brakes, in order to assist the car 58 or truck 60 in slowing down. This may be accomplished through a clutch such as is well known in the art including, but not limited to, an electrically activated clutch located between the electrical generator 34, air compressor 38, hydraulic pump or fluid or gas pump and the propeller axis 30. This assist in braking is due to the increase of drag caused by the resistance to movement of the propellers 24 in their functional configuration to produce electricity or compressed air.

Although the wind devices 10 have been described here is being connected to cars 58 and trucks 60, such wind devices 10 could be attached to any moving apparatus including, but not limited to, buses, trains, ships, bicycles and planes.

With respect to placing wind devices 10 on ships, it may be particularly useful to place such wind devices 10 on aircraft carriers since aircraft carriers are turned into the wind in order to enable the takeoff and landing of aircraft. As a result, there will always be a wind blowing directly down the ship as the aircraft carrier moves into the wind. Further, although the wind devices 10 have been described as preferably being located near the departure end of a runway 70 to capture the prop blast orjet wash of departing aircraft, such wind devices 10 may also be used on aircraft carriers to capture the prop blast or jet wash of landing aircraft since such aircraft typically land on carriers with full power.

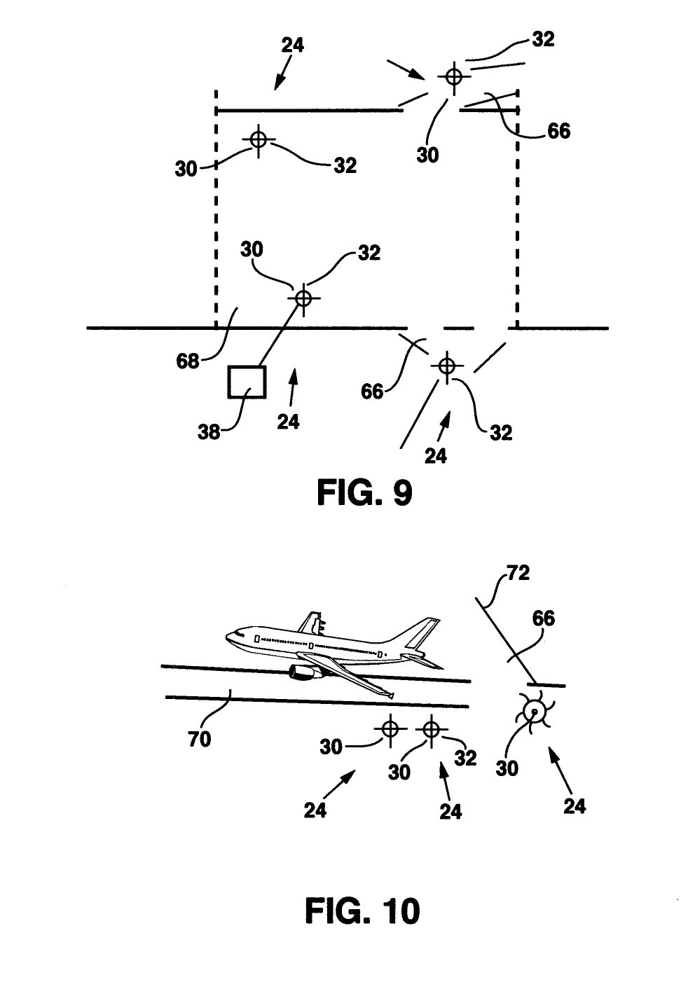

In another variant of the invention shown in FIG. 9, the wind devices 10 may be placed near, on or in tunnels 68 so that wind movement through the tunnels 68 or movement of wind through tunnels 68 generated by passing cars, trucks or trains or all or any combination of these may interact with the wind devices 10 to produce the desired benefits described above. In this embodiment as well, the wind devices 10 may be placed so that they can contact the wind directly or may be placed remotely from where the wind is captured and directed to contact the wind devices 10 through one or more ducts 66.

In another variant of the wind device 10 shown in FIG. 10, one or more wind devices 10 may be placed near the ends of or along the departing end of runways 70 so that propeller blast or jet wash from departing aircraft may be captured by the wind devices 10 and converted into other forms of energy as described above. These wind devices 10 may be placed above the ground near the runway 70 or may be placed below ground where the wind from the propeller blast or jet wash can be directed through ducting 66, possibly through the opening of a trap door 72, to contact the wind devices 10.

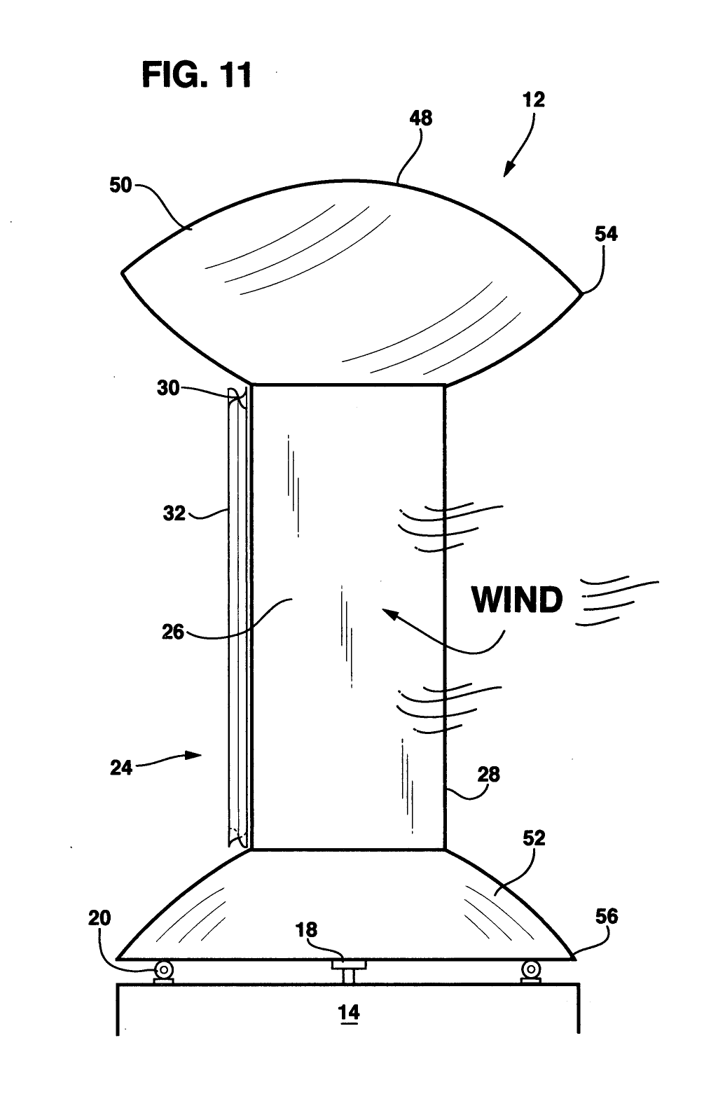

In a further variant of the wind device 10 shown in FIG. 11, a propeller 24 may have a top piece 50 or a bottom piece 52 or both. The top piece 50, bottom piece 52 or both captures and directs incident wind together onto the vanes 32 preferably through a Venturi effect so that the speed of the wind is increased. As a result, the top piece 50, bottom piece 52 or both produces a more beneficial interaction with the vanes 32 of the propellers 24.

In a preferred embodiment of the invention shown in FIG. 11, the top piece 50 is concave so that the top piece 50 is bowl shaped. Conversely, the bottom piece 52 is convex so that the bottom piece 52 has an “upside down” bowl shape. The top piece 50 and the bottom piece 52 each have a wind contacting edge, 54, 56, respectively. In this way, wind contacting the wind contacting edges 54, 56 will be squeezed together as it approaches the vanes 32. According to the Venturi principal, this squeezing will cause the wind to speed up so that the wind contacting the vanes 32 will contact the vanes 32 at a speed higher than the incident wind would have without the top piece 50 or the bottom piece 52. In a preferred embodiment of this invention, at least the top piece 50 is covered with a solar panel 48 as described above although the bottom piece 52 may be covered as well or in the alternative.

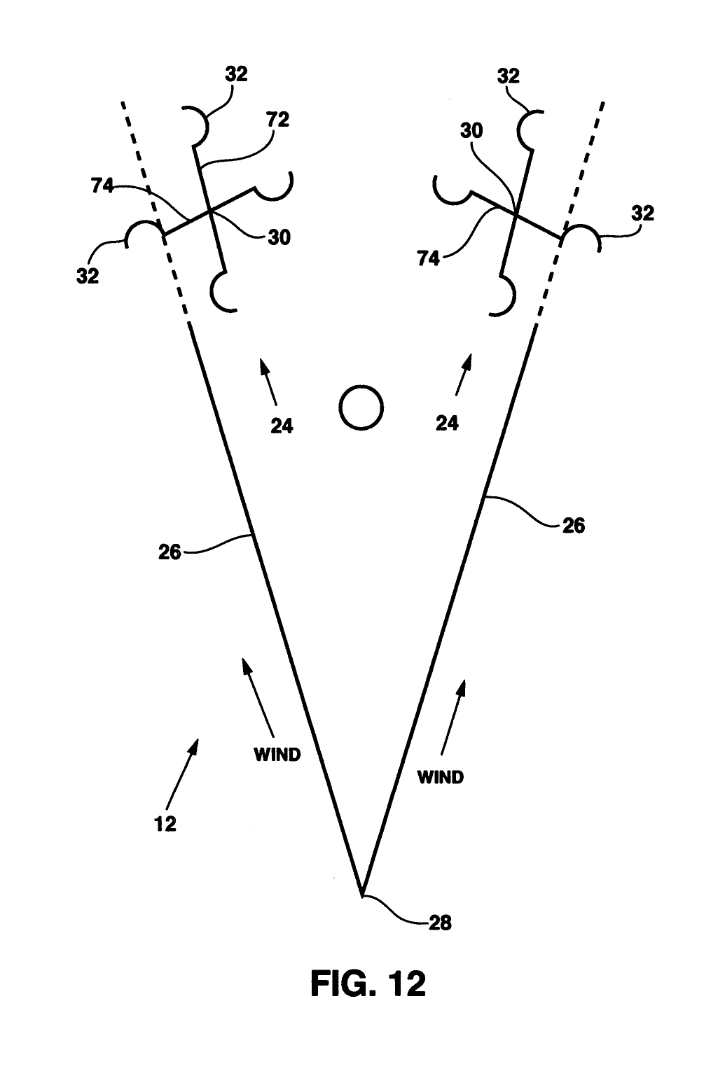

In another embodiment of the wind device shown in FIG. 12, each vane 32 is located a distance from the propeller axis 30. This may be accomplished by placing a vane on the end of a connector arm 74 that extends from the propeller axis 30. As a result, there is greater torque imparted to the propeller axis 30, and ultimately to the electrical generator 34, air compressor 38, hydraulic pump or fluid or gas pump by the interaction of the wind and a vane 32. This embodiment may be particularly useful in areas where or at times when the wind contacting a vane 32 is light. In this embodiment, it is preferable although not absolutely required that only the vane 32 be exposed to the wind. In this embodiment as well, the propeller axis 30 may be oriented horizontally, vertically or any angle in between as desired to place the vanes 32 in contact with the wind and to make the wind device 10 aesthetically pleasing.

The wind device 10 of the present invention may either be permanently located at a desired location or may be portable. Where the wind device 10 is portable, the wind device 10 may be transported to a desired location, set up and the electricity, compressed air or hydrogen and oxygen may be used at that location as desired.

As described above, the wind device 10 may be located on or in buildings. This may allow the wind devices 10 to better fit into the landscape than if they were free standing. As a result, there may be less public resistance to erecting such wind devices 10 than there has been with erecting windmills of the turbine blade models, particularly where such turbine blade windmills are free standing. Another advantage of the design of the present wind device 10 is that by incorporating the wind device 10 into or onto buildings or other structures, the wind device 10 will have less negative effect on radar compared to the turbine blade windmills. Even where the wind device 10 is not incorporated into or onto structures such as buildings, the present wind device 10 will likely have less negative effect on radar compared to the turbine blade windmills because of its ability to be oriented in a horizontal direction (i.e., the propeller axis 30 is oriented horizontally) thereby making the wind device 10 not as tall as turbine blade windmills.

While the above description contains many specificities, these should not be construed as limitations on the scope of the invention, but rather as examples of preferred embodiments thereof. As a result, the description contained herein is intended to be illustrative and not exhaustive. Many variations and alternatives of the described technique and method will occur to one of ordinary skill in this art. Variations in form to the component pieces described and shown in the drawings may be made as will occur to those skilled in the art. Further, although certain embodiments of a wind system 10 have been described, it is also within the scope of the invention to add other additional components or to remove certain components such as the solar panel 48. Also, variations in the shape or relative dimensions of the top piece 50 and bottom piece 52 or the top 46 will occur to those skilled in the art and still be within the scope of the invention.

All these alternatives and variations are intended to be included within the scope of the attached claims. Those familiar with the art may recognize other equivalents to the specific embodiments described herein which equivalents are also intended to be encompassed by the claims attached hereto. As a result, while the above description contains may specificities, these should not be construed as limitations on the scope of the invention but rather as examples of different embodiments thereof.

I claim:

1. A device for converting wind energy into other forms of energy comprising:
(a) a wind collector having:
(i) a wind vane splitter to split and direct wind to contact at least one propeller; and
(ii) at least one propeller, each propeller having a propeller axis having a top and a bottom and at least a portion of each propeller contacts the wind wherein the propeller rotates around the propeller axis in response to contact between the wind and the propeller;
(b) a support structure to securely support and place the wind collector in a position to be contacted by and interact with the wind; and
(c) means for converting rotational motion of a propeller around the propeller axis into other forms of usable energy.

2. The device of claim 1 wherein the support structure is anchored in the ground so that the support structure supports the wind collector above the ground.

3. The device of claim 2 wherein the support structure is a concrete pillar placed into the ground and extending a distance above the ground to support the wind collector.

4. The device of claim 2 wherein the support structure is chosen from the group consisting of a tower, platform, silo, tower, bridge, billboard or building.

5. The device of claim 2 wherein at least a portion of the device is placed along the side of a structure so that wind can contact the wind collector.

6. The device of claim 1 further comprising a turntable placed between the wind collector and the support structure wherein the turntable allows the wind collector to rotate relative to the support structure.

7. The device of claim 6 wherein the turntable has a pivot to allow the wind collector to be turned so as to have maximum beneficial interaction with the available wind.

8. The device of claim 7 wherein the turntable further comprises a series of rollers placed between the support structure and the wind collector to allow the turntable to rotate around the pivot.

9. The device of claim 1 wherein the wind vane splitter has a “V” shaped configuration formed by two legs extending away from a point.

10. The device of claim 9 wherein the wind collector has at least two propellers located at the open ends of the legs of the “V” shaped wind vane splitter.

11. The device of claim 1 wherein at least one propeller is vertically oriented as it rotates around the propeller axis.

12. The device of claim 1 wherein at least one propeller has at least one vane extending radially away from the propeller axis.

13. The device of claim 12 wherein at least one vane is a flat slat.

14. The device of claim 12 wherein at least one vane has a cup-shaped slat.

15. The device of claim 12 wherein at least one vane has a helical slat.

16. The device of claim 12 wherein at least one vane has a curved slat.

17. The device of claim 1 wherein each vane is located a distance from the propeller axis.

18. The device of claim 17 further comprising a connector arm attached to and extending away from the propeller axis and wherein at least one vane is attached to the end of the connector arm.

19. The device of claim 1 wherein at least one propeller axis is rigidly but rotatably attached to the wind vane splitter at both the top and bottom of the propeller axis.

20. The device of claim 1 wherein approximately about half of the propeller is exposed to the wind passing down the legs of the wind vane splitter.

21. The device of claim 1 wherein the means for converting rotational motion of a propeller around the propeller axis into other forms of usable energy is chosen from the group consisting of an electrical generator, air compressor, hydraulic pump or fluid or gas pump.

22. The device of claim 1 wherein the means for converting rotational motion of a propeller around the propeller axis into other forms of usable energy is an electrical generator and further comprising an exchange battery connected to the electrical generator for storing the electrical energy generated by the electric generator.

23. The device of claim 1 wherein the means for converting rotational motion of a propeller around the propeller axis into other forms of usable energy is an electrical generator wherein the electoral generator produces electricity that is directly applied to water to create hydrogen and oxygen through electrolysis and wherein the hydrogen and oxygen is collected and used to produce energy through combustion.

24. The device of claim 1 further comprising a system to turn the wind collector into the wind including a small wind vane that senses the direction of the wind and sends a signal to a control system that has a mechanism to turn the wind collector into the wind to provide maximum contact between the wind and the propellers.

25. The device of claim 24 wherein the mechanism is a motor that interacts with the turntable to rotate the wind collector into a desired configuration with respect to the wind.

26. The device of claim 1 further comprising a top covering at least the wind vane splitter.

27. The device of claim 26 further comprising a solar panel located at least in part on the top to converts sunlight into electrical energy.
The solar panel is preferably connected to the electrical system that the electrical generator is attached to where there is an electrical generator as described above or may produce an independent application of electrical energy whether there is an electrical generator or not.

28. The device of claim 1 further comprising a vehicle chosen from the group consisting of a car, truck, buses, trains, ships, bicycles and planes wherein the wind collector is attached to the vehicle so that as the vehicle moves, the wind generated by the movement, in addition to any naturally occurring wind if any, may be used to turn the propellers.

29. The device of claim 28 wherein at least one propeller is located so that approximately half of each propeller is exposed to the wind while the other half of each propeller is sheltered from the wind.

30. The device of claim 28 wherein a propeller is located at a location on the vehicle chosen from the group consisting of the roof of the vehicle, along the bottom surface of the vehicle or the side of the vehicle.

31. The device of claim 28 further comprising a solar panel for generating electricity in response to sunlight impinging on the solar panel, the solar panel located on at least a portion of the outer surface of the vehicle.

32. The device of claim 28 further comprising at least one deflector functionally located close to a particular propeller to control the amount of and even whether any wind contacts the propellers.

33. The device of claim 32 wherein the deflector is movable to a first position to deflect the wind over a propeller at a desired time and move to a second position to allows a desired amount of wind contact with the propellers.

34. The device of claim 28 further comprising at least one duct that captures a portion of the wind and direct it into contact with propeller.

35. The device of claim 1 further comprising a clutch located between the means for converting rotational motion of a propeller around the propeller axis into other forms of usable energy and the propeller axis for allowing the propeller to free-wheel at selected times and be connected to the means for converting rotational motion of a propeller around the propeller axis into other forms of usable energy at other selected times.

36. The device of claim 28 wherein the vehicle is an aircraft carrier.

37. The device of claim 1 wherein the wind collector is located near the departure end of a runway to capture the prop blast or jet wash of departing aircraft.

38. The device of claim 1 wherein the wind collector is located near, on or in a tunnel so that wind movement through the tunnels or movement of wind through tunnels generated by passing vehicles or all or any combination of these may interact with the wind collector.

39. The device of claim 1 wherein a propeller includes a top piece or a bottom piece or both wherein the top piece, bottom piece or both captures and directs incident wind onto the vanes through a Venturi effect so that the speed of the wind is increased.

40. The device of claim 39 wherein the top piece is concave so that the top piece is bowl shaped and has a wind contacting edge and the bottom piece is convex so that the bottom piece has an “upside down” bowl shape and has a wind contacting edge so that the wind contacting edges will be squeezed together as it approaches the vanes.

41. A device for converting wind energy into other forms of energy comprising:
(a) a wind collector having:
(i) a wind vane splitter to split and direct wind to contact at least one propeller wherein the wind vane splitter has a “V” shaped configuration formed by two legs extending away from a point; and
(ii) at least one propeller, each propeller having a propeller axis having a top and a bottom and at least a portion of each propeller contacts the wind wherein the propeller rotates around the propeller axis in response to contact between the wind and the propeller, wherein at least one propeller axis is rigidly but rotatably attached to the wind vane splitter at both the top and bottom of the propeller axis;
(b) a support structure to securely support and place the wind collector in a position to be contacted by and interact with the wind;
(c) a turntable placed between the wind collector and the support structure wherein the turntable allows the wind collector to rotate relative to the support structure; and
(d) means for converting rotational motion of a propeller around the propeller axis into other forms of usable energy.

42. The device of claim 41 further comprising a vehicle chosen from the group consisting of a car, truck, buses, trains, ships, bicycles and planes wherein the wind collector is attached to the vehicle so that as the vehicle moves, the wind generated by the movement, in addition to any naturally occurring wind if any, may be used to turn the propellers.

43. A device for converting wind energy into other forms of energy comprising:
(a) a wind collector having:
(i) a wind vane splitter to split and direct wind to contact at least one propeller wherein the wind vane splitter has a “V” shaped configuration formed by two legs extending away from a point; and
(ii) at least one propeller, each propeller having a propeller axis having a top and a bottom and at least a portion of each propeller contacts the wind wherein the propeller rotates around the propeller axis in response to contact between the wind and the propeller, wherein at least one propeller axis is rigidly but rotatably attached to the wind vane splitter at both the top and bottom of the propeller axis;
(c) a top covering at least the wind vane splitter, the top including a solar panel located at least in part on the top to converts sunlight into electrical energy;
(d) a support structure to securely support and place the wind collector in a position to be contacted by and interact with the wind;
(e) a turntable placed between the wind collector and the support structure wherein the turntable allows the wind collector to rotate relative to the support structure; and
(f) means for converting rotational motion of a propeller around the propeller axis into other forms of usable energy.

44. The device of claim 43 further comprising a vehicle chosen from the group consisting of a car, truck, buses, trains, ships, bicycles and planes wherein the wind collector is attached to the vehicle so that as the vehicle moves, the wind generated by the movement, in addition to any naturally occurring wind if any, may be used to turn the propellers.

45. A device for producing usable energy from natural sources comprising:
(a) a windmill having at least a member contacting the wind and moving in a rotational direction in response to contact with wind and having means for converting rotational motion of the member into other forms of usable energy; and
(b) a solar panel to convert sunlight into electrical energy.
